(19) United States
(12) Patent Application Publication
(10) Pub. No.: US 2004/0198457 A1
(43) Pub. Date: Oct. 7, 2004

(54) Information processing terminal

(75) Inventors: Ken Hayashida, Kawasaki (JP); Yoko Fujii, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/365,429

(22) Filed: Feb. 13, 2003

(30) Foreign Application Priority Data
Jul. 30, 2002 (JP) 2002-221530

(51) Int. Cl. H04B 1/38

(52) U.S. Cl. 455/566; 455/550.1

(57) ABSTRACT

A technology provides a cellular phone and an event display program that are capable of improving a visual recognizability or operability when displaying characters representing an event received. An occurrence of the event is detected, a character count of the characters to be displayed is detected based on the detected event, a character display size is determined corresponding to this character count, and the characters corresponding to the event are searched out of a character storage unit and displayed in the determined display size.

### BACKGROUND OF THE INVENTION

The present invention relates to an information processing terminal including a display unit for displaying characters such as letters and numerals.

The category of the information processing terminals according to the present invention includes a cellular phone, a PHS (Personal Handy phone System), a PDA (Personal Digital Assistant), a PC (Personal Computer) and so on.

A pocket-sized information processing terminal such as the cellular phone and a pager is structured to display characters such as letters, numerals, icons or pictograms etc by utilizing a display unit constructed generally of a liquid crystal display panel.

Further, some of foldable cellular phones are provided with a small-sized sub-display positioned on an outer surface when folding the cellular phone with a main display directed inside. This design makes it possible to display a battery level, information showing whether a new mail is received and so on even when folded.

The information processing terminal described above is configured in compact with an emphasis put on its portability, and is therefore limited in terms of its size (a real size) of the display unit.

Especially, the sub-display of the foldable cellular phone is an attendant component, and it is therefore typical that the sub-display is configured in the size minimal enough to display necessary pieces of information.

The sub-display is, however, designed to display a multiplicity of categories of information such as the information indicating states of the cellular phone such as the battery level, a receiving electric field level etc, information indicating event statuses such as a call received during the absence, a new mail received, a voice message left, and so forth.

Accordingly, if these multiple categories of information are all laid out and thus displayed on the sub-display, the characters indicating the information become too small. Namely, a problem is that the characters are small and therefore hard to see, easy to misread and liable to decline in its visual recognizability.

Further, some information processing terminals are structured not to display the multiple categories of information at the same time but to change over the information to be displayed by use of a switch while displaying some categories of information. In this case, however, the change over of displaying involves a labor, resulting in such a problem that the operability declines.

It is an object of the present invention, which was devised to obviate the problems inherent in the prior art to provide a technology capable of improving the visual recognizability and the operability when displaying the characters representing the event received.

### SUMMARY OF THE INVENTION

To accomplish the above object, in an information processing terminal, an event display method and a storage medium stored with an event display program according to the present invention, an occurrence of the event is detected, a character count of the characters to be displayed is detected based on the detected event, a character display size is determined corresponding to this character count, and the characters corresponding to the event are searched out of a character storage unit stored with sets of characters corresponding to the events and displayed in the determined display size.

With this architecture, the characters indicating that there is the event occurred are displayed in a proper size corresponding to the character count, thus enabling the characters to be displayed efficiently in the limited display area and improving the visual recognizability. Moreover, the operability is enhanced by eliminating the operation such as switching over the display.

For example, the characters are displayed in away that reduces the display size if the character count is small and enlarges it if the character count is large. This scheme enables the characters to be displayed as largely as possible in the limited display area, thereby improving the visual recognizability.

According to one aspect of the present invention, an information processing terminal has a character storage unit storing characters corresponding to an event, an event detection unit detecting an occurrence of the event, a character count detection unit detecting a character count of characters displayed based on the event detected by said event detection unit, a size determining unit determining a character display size corresponding to the character count, a character search unit searching out the characters corresponding to the event detected by said event detection unit from said character storage unit, and a display control unit having the characters displayed in the display size.

In the information processing terminal, the display control unit may display, in the case of displaying plural categories of characters, the characters in a predetermined sequence corresponding to these categories.

In the information processing terminal, the size determining unit may determine the display size so as to obtain a size into which the display area is equally divided by the character count.

In the information processing terminal, the display control unit may display the characters in a way that arrays the characters in a plurality of directions.

According to another aspect of the invention, a storage medium stored with an event display program executed by a computer, includes detecting an occurrence of an event, detecting a character count of characters displayed based on the event detected, determining a character display size corresponding to the character count, searching out the characters corresponding to the detected event from a character storage unit, and having the characters displayed in the display size.

In the storage medium stored with the event display program executed by the computer, the display of the characters may involve displaying the characters in a predetermined sequence corresponding to categories of the characters.

In the storage medium stored with the event display program executed by the computer, the determination of the size may involve determining the display size so as to obtain a size into which the display area is equally divided by the character count.

In the storage medium stored with the event display program executed by the computer, the display of the characters may involve displaying the characters in a way that arrays the characters in a plurality of directions.

According to a further aspect of the invention, an event display method executed by an information processing terminal, includes detecting an occurrence of an event, detecting a character count of characters displayed based on the event detected, determining a character display size corresponding to the character count, searching out the characters corresponding to the detected event from a character storage unit, and having the characters displayed in the display size.

In the event display method executed by the information processing terminal, the display of the characters may involve displaying the characters in a predetermined sequence corresponding to categories of the characters.

In the event display method executed by the information processing terminal, the determination of the size may involve determining the display size so as to obtain a size into which the display area is equally divided by the character count.

In the event display method executed by the information processing terminal, the display of the characters may involve displaying the characters in a way that arrays the characters in a plurality of directions.

<Readable-By-Computer Recording Medium>

The recording medium described above is stored with the program readable by the computer, and the program stored thereon is read and executed by the computer, thereby providing the functions described above.

Herein, the readable-by-computer recording medium includes recording mediums capable of storing information such as data, programs, etc. electrically, magnetically, optically and mechanically or by chemical action, which can be all read by the computer. What is demountable out of the computer among those recording mediums maybe, e.g., a floppy disk, a magneto-optic disk, a CD-ROM, a CD-R/W, a DVD, a DAT, an 8 mm tape, a memory card, etc.

Further, a hard disk, a ROM (Read Only Memory) and so on are classified as fixed type recording mediums within the computer.

<Information Processing Terminal>

The following embodiment will exemplify a case where the present invention is applied to a cellular phone, however, the present invention is not limited to the cellular phone and can be widely applied to information processing terminals capable of displaying the characters, such as a mobile telephone, a PHS (Personal handyphone System), a PDA (Personal Digital Assistant), a PC (Personal computer) and so on.

According to the present invention, the components described above can be combined to the greatest possible degree.

### BRIEF DESCRIPTION OF THE DRAWINGS

FIG. 1 is an explanatory view showing a cellular phone according to the present invention;

FIG. 2 is a block diagram of the cellular phone according to the present invention;

FIG. 3 is an explanatory flowchart showing an event display method;

FIGS. 4(a) through 4(e) are diagrams showing examples of displaying characters;

FIGS. 5(a) through 5(e) are diagrams showing examples of displaying the characters; and

FIGS. 6(a) through 6(e) are diagrams showing examples of displaying the characters.

### DETAILED DESCRIPTION OF THE PREFERRED EMBODIMENT

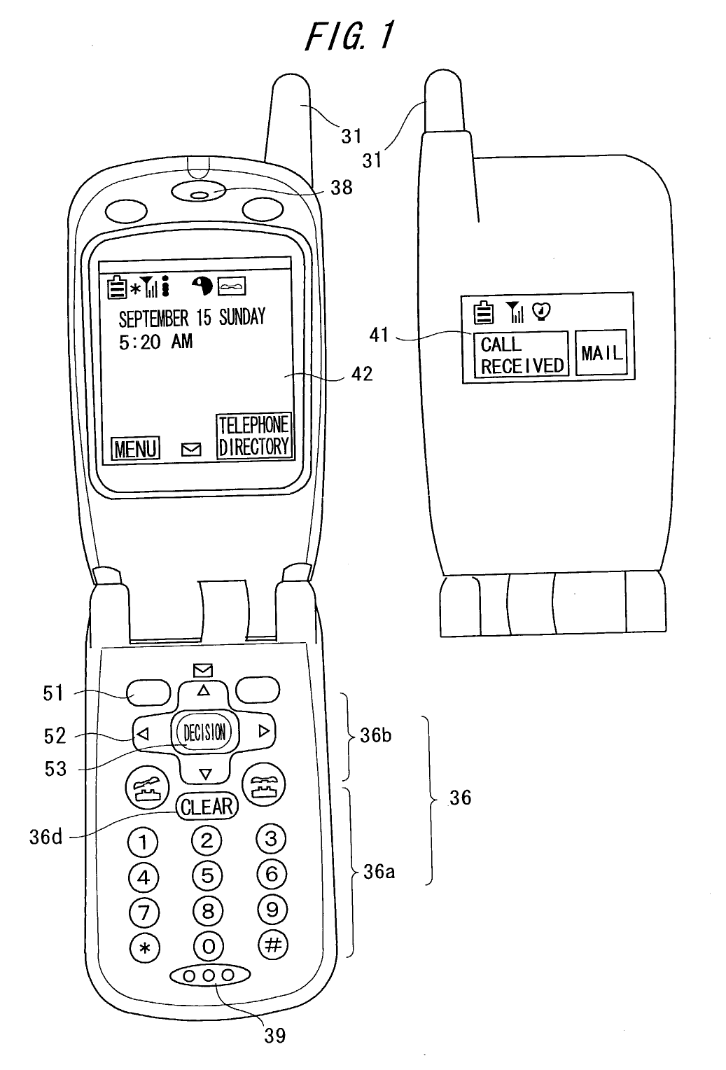

An example of applying the present invention to a cellular phone will be described by way of one mode of an information processing terminal (computer) of the present invention with reference to FIGS. 1 through 6.

§1. Whole Architecture

FIGS. 1(a) and 1(b) are views showing an example of a guidance display on a cellular phone in this embodiment. FIG. 1(a) illustrates the cellular phone when used, i.e., its unfolded state. FIG. 1(b) shows a folded state thereof.

A cellular phone 1, when there occurs an event such as receiving a mail, a message, a telephone call (call receiving) etc when in a waiting status, displays characters corresponding to this event on a sub-display 41.

The cellular phone 1 in this embodiment, on the occasion of displaying the same characters, determines a display size corresponding to the number of characters, and displays the characters in a proper size, thereby efficiently utilizing a display area on the display 41 and improving a visual recognizability and an operability as well.

§2. Architecture of Cellular Phone

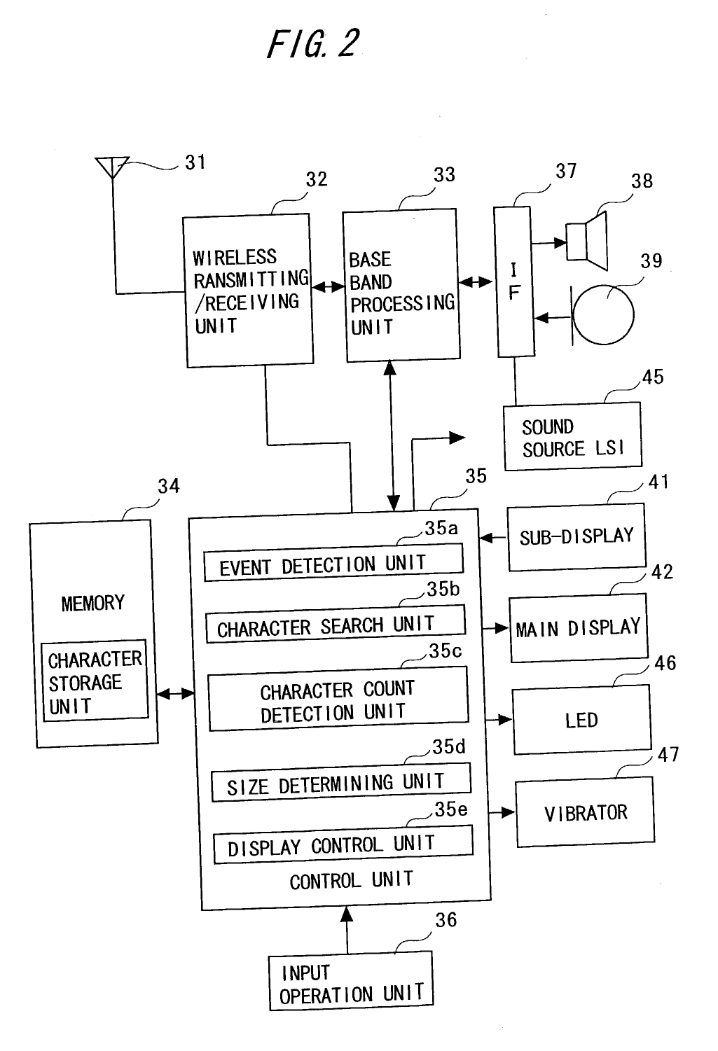

Next, architecture of the cellular phone in this embodiment will be explained. FIG. 2 is a block diagram showing the cellular phone 1 according to the present invention.

As shown in FIG. 2, the cellular phone 1 includes an antenna 31, a wireless transmitting/receiving unit 32, a base band processing unit 33, a memory unit (storage unit) 34, a control unit 35, an input operation unit 36, and I/O interface (IF) 37, a voice output unit (speech receiving unit) 38, a voice input unit (speech sending unit) 39, a sub-display (corresponding to a display unit according to the present invention) 41, a main display 42, a sound source LSI 45, an LED (Light Emitting Diode) 46 and a vibrator 47.

The antenna 31 is used for transmitting and receiving radio waves when performing communications with a radio base station (unillustrated). The wireless transmitting/receiving unit 32 generates receiving data by demodulating the radio waves received by the antenna 31, then modulates transmitting data into a predetermined frequency, and outputs the modulated signals via the antenna 31.

The base band processing unit 33 executes processing such as decoding the demodulated signals generated by the wireless transmitting/receiving unit 32, outputting the coded transmitting data to the wireless transmitting/receiving unit 32, and thus having the communications performed, and so forth.

The memory unit 34 is constructed of a proper memory such as a flash memory, an SRAM (Static Random Access Memory), an NVRAM (Nonvolatile Random Access Memory) etc., and is stored with phone number data, data of mails delivered and received, data of messages, an application program and so on. Further, the memory unit 34 retains a character table (a character storage unit) structured to store characters corresponding to events.

The input operation unit 36 is constructed of operation keys 36a for inputting the phone numbers and characters, operation keys 36b for selecting selection menus, and so forth. The input operation unit 36 may involve the use of input dials (rotating dials), a touch panel, etc in addition to the operations keys described above.

The I/O interface 37, after receiving voice data decoded by the base band processing unit 33 and decoding the same data in specifications based on a voice coding system, executes an analog conversion thereof and outputs the thus converted data as voice signals to the voice output unit 38. Further, the I/O interface 37, after executing a digital conversion of the voice signals inputted from the voice input unit 39, encodes the thus converted signals in the specifications based on the voice coding system and outputs them as voice data to the base band processing unit 33.

The voice output unit 38 is constructed of a loudspeaker and an amplifier, and outputs the voice signals as a voice. The voice input unit 39 is constructed of a microphone and an amplifier, and inputs a voice of a speaker as voice signals described above.

The sub-display 41 is constructed of a proper display device such as an LCD (Liquid Crystal Display), an EL (electro luminescent) display etc., and is controlled by the control unit 35 to display the characters etc corresponding to events.

Similarly, the main display 42 is constructed of the display device such as the LCD, the EL display etc., and is controlled by the control unit 35 to display a telephone number, a content of the mail, a wait image etc.

The sound source LSI 45 is stored with sound data of music, a calling sound etc., and is, when there occurs an event such as receiving a telephone call, a mail etc., controlled by the control unit 35 to output a sound corresponding to the event via the I/O interface 37 from the voice output unit 38 or other loudspeaker (unillustrated).

The LED 46 and the vibrator 47 are likewise, upon an occurrence of an event, controlled by the control unit 35 to emit the light or make vibrations.

The control unit 35 is constructed of a CPU (Central Processing Unit), a main memory and so on. The control unit 35 executes, based on the information given from the respective units and application software, arithmetic processing, thereby actualizing functions of an event detection unit, a character search unit, a character count detection unit, a size determining unit, a display control unit, a message control unit and a mail control unit.

The control unit 35 receives, as the function of the event detection unit 35a, the data decoded by the base band processing unit 33 and detects the occurrence of the event on the basis of the same data.

Further, the control unit 35 searches out, as the function of the character search unit 35b, the characters corresponding to the event from the character storage unit.

The control unit 35 detects, as the function of the character count detection unit 35c, the number of characters (which will hereinafter be called a character count) searched out.

The control unit 35 determines, as the function of the size determining unit 35d, a character display size corresponding to the character count.

The control unit 35 displays, as the function of the display control unit 35e, the characters in the determined display size on the sub-display 41.

The control unit 35 answers in voice, as the function of the message control unit, such as [Try to record the message after the feep] if a user does not answer to a telephone call, thus prompting the user to input the message. Then, when the message is inputted, the control unit 35 stores this message on the memory unit 34.

The control unit 35 receives, as the function of the mail control unit, mail data via the wireless transmitting/receiving unit 32, stores the same mail data on the memory unit 34. Further, the control unit 35 generates the mail data based on an input from the input operation unit 36 and outputs the mail data to the wireless transmitting/receiving unit 32. E-mail is thereby delivered to a terminal as the other communication party via the radio base station. Moreover, the control unit 35 reads the received mail data from the memory unit 34, and displays a content of the mail on the main display 42.

This embodiment takes, as described above, the architecture that the control unit 35 executes a part of the functions based on the software, however, the respective units may be configured by electronic circuits (hardware) that execute these functions.

§3. Method of Displaying Characters Corresponding to Event

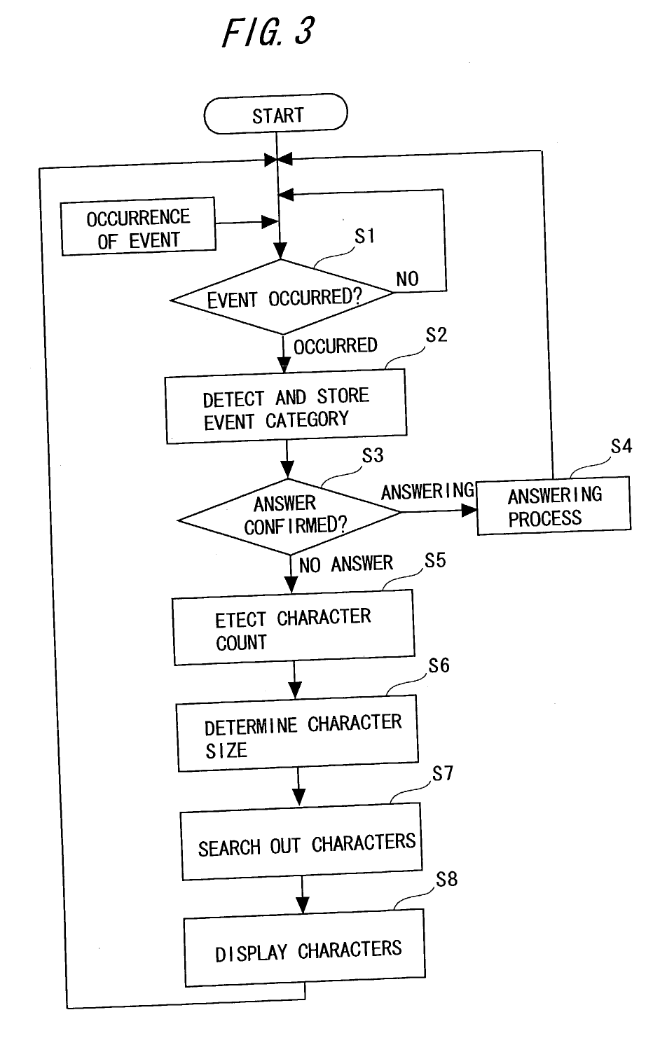

A character display method on the cellular phone described above will be explained referring to FIG. 3.

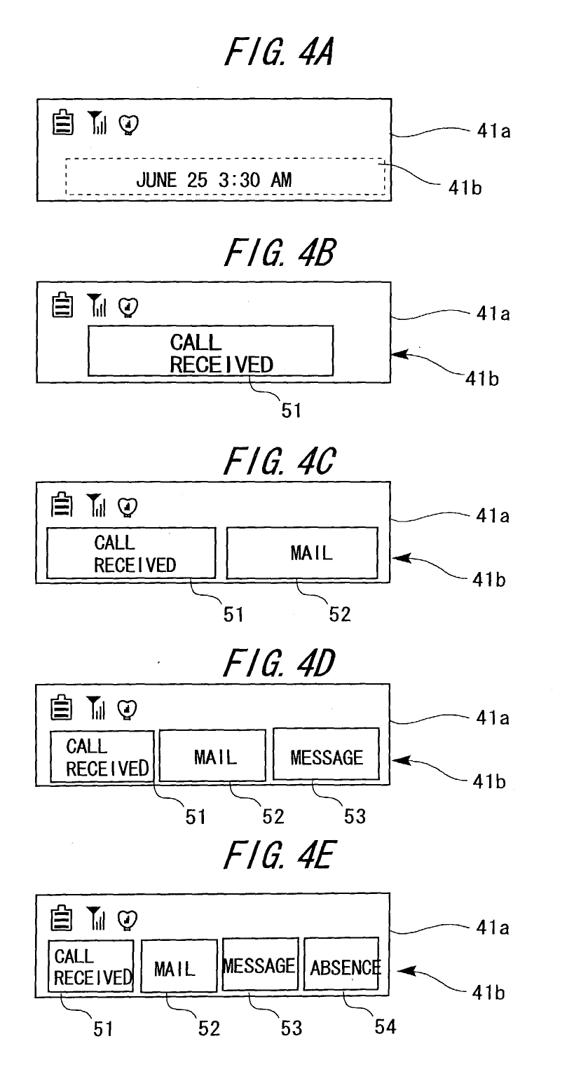

The cellular phone 1, upon a start of processing after switching ON the power source, at first judges, as the function of the event detection unit, whether an event occurs or not (Step 1: “Step” used in the following discussion will be abbreviated to “S” such as S1). Herein, if the event does not occur, the cellular phone 1 repeats this judgement and comes to a standby status. Note that if the should-be-displayed event is not yet detected, as shown in FIG. 4(a), not the characters but date/time information is displayed in an area (defined by a dotted line) 41b for displaying the characters within a display area (defined by a solid line) on the dub-display 41.

On the other hand, when receiving the radio waves from a radio base station, the cellular phone 1 demodulates the radio waves by use of the wireless transmitting/receiving unit 32 and detects, as the function of the event detection unit, the occurrence of the event from the demodulated data and a category of the event as well.

Then, the control unit 35 stores the occurrence of the event and the event category information on the memory unit 34 (S2: the function of the event detection unit).

Next, the control unit 35 judges whether a response to this event is given or not (S3: the function of the event detection unit). When the user indicates the response to this event by operating the input operation unit 36, the control unit 35 makes this response (S4).

For example, if the event is a receipt of a mail and if the user indicates displaying the mail received, the control unit 35 displays, as the function of the mail control unit, this mail on the main display 42. Further, if the event is a receipt of a message and if the user indicates reproducing the message, the control unit reproduces, as the function of the message control unit, this message, and the reproduced message is outputted from the voice output unit 38. Similarly, if the event is a receipt of a call, the control unit 35 displays a call receiving history on the main display 42 and dials up the caller.

Then, upon a completion of the response, the control unit 35 deletes the event information stored on the memory unit, and returns to the standby status in S1.

Further, if there is any answer in S3 (no answer), the control unit 35 detects, as the function of the character count detection unit, an event count i.e., the number of characters to be displayed, which is stored on the memory unit 34.

Next, the control unit 35 determines, as the function of the size determining unit, a display size based on the character count detected in S5 (S6).

Subsequently, the control unit 35 searches out, as the function of the character search unit, data of the characters displayed corresponding to the category of the event stored on the memory unit 34 from a character table of the memory unit 34 (S7).

Then, the control unit 35 displays, as the function of the display control unit, the characters searched out in S7 on the sub-display 41 in the display size determined in S6 (S8). For instance, if the event category is the receipt of the call and if the event count is 1, as shown in FIG. 4 (b), characters 51 corresponding to the receipt of the call are displayed in the maximum size substantially at the center of the display area 41b. The cellular phone 1, upon a completion of this display, returns to the standby status in S1, wherein the cellular phone 1 repeats the above steps each time an event occurs and displays the characters.

For example, if an event such as receiving a mail occurs subsequently to the receipt of the call, as shown in FIG. 4 (c), the cellular phone displays the characters 51 corresponding to the receipt of the call and characters 52 representing the receipt of the mail in sizes into which the display area 41b is equally divided.

Similarly, if there occur events of receiving the call, the mail and a message, as shown in FIG. 4 (d), the characters 51 corresponding to the receipt of the call, the characters 52 representing the receipt of the mail and characters 53 corresponding to the receipt of the message, are displayed in sizes into which the display area 41b is equally divided. Further, in addition to the event described above, when receiving a signal showing that a message is sent from a telephone answering center during a user's absence (implying a case where the cellular phone exists far beyond a reach of the radio waves and a case where the its power source is switched OFF) (if an absence event occurs), as shown in FIG. 4(f), the characters 51 through characters 54 are displayed.

Thus, a method of displaying the characters 51 through the characters 54 in a way that varies the display size involves, for example, storing beforehand the character table with the characters in respective sizes, and searching out in S7 the character in the size determined in S6. Further, this method may involve changing a magnification in S8 so that the character searched out in S7 matches with the size described above, and displaying this character.

Moreover, the control unit 35 in this embodiment, on the occasion of displaying this character, displays the respective characters in predetermined sequences corresponding to types thereof. Namely, as shown in FIG. 4(e), [call received], [mail], [message] and [absence] are displayed in this sequence from the left as viewed from the front.

For instance, if the events occur in the sequence of [mail], [message] and [call received], the events are not laid out in the occurrence sequence but are rearranged in the sequence of [call received], [mail] and [message] as shown in FIG. 4(d).

As discussed above, according to this embodiment, the characters representing the events stored are displayed in the variable display sizes in a way that enlarges the size when the character count is small and reduces the size when the character count is large. With this scheme, the characters shown to the user can be highly efficiently displayed in the limited display area, whereby the visual recognizability or the operability can be improved.

Hence, according to this embodiment, the visual recognizability or the operability can be preferably improved also in the case of utilizing a small-sized display as on the sub-display of the foldable cellular phone.

Further, according to this embodiment, the characters are displayed in the predetermined sequence, and hence, if the event is the receipt of the call, this event is displayed in the most leftward position. If the event is the mail, this is displayed in the first or second position from the left, and whether there is the event or not can be confirmed by checking this specified position, thereby facilitating the confirmation of whether the event exists or not.

<Modified Example 1>

The embodiment discussed above has exemplified the case of displaying the characters in the horizontal direction, however, the characters are displayed in the vertical direction in a modified example 1. Note that other configurations are substantially the same.

In the modified example 1, the control unit 35, on the occasion of displaying the characters, displays the characters in a way that arranges them in the vertical direction, and a vertical size of the character is determined in S6.

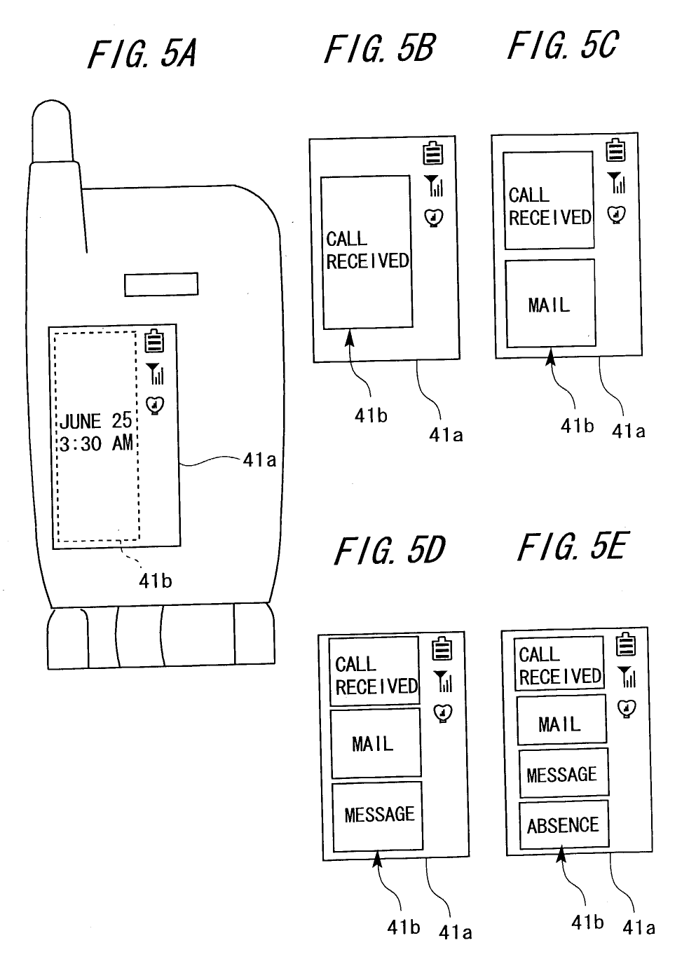

FIG. 5(a) illustrates the sub-display 41 in the standby status, and the character display area 41b on this sub-display 41 is defined by a dotted line.

Then, FIG. 5(b) shows an example of displaying one category of characters. FIG. 5(c) shows an example of displaying two categories of characters. FIG. 5(d) shows an example of displaying three categories of characters. FIG. 5 (e) shows an example of displaying four categories of characters.

Thus, according to the present invention, the same effects as those in the embodiment discussed above can be obtained even by the scheme of displaying the characters in the vertical direction.

<Modified Example 2>

The embodiment discussed above has exemplified the case of displaying the characters in one row, however, the characters are displayed in a plurality of lines in a modified example 2. Note that other configurations are substantially the same.

In this modified example 2, the control unit 35, on the occasion of displaying the characters, displays the characters by arranging them in the vertical and horizontal directions, and determines in S6 vertical and horizontal sizes corresponding to the character count.

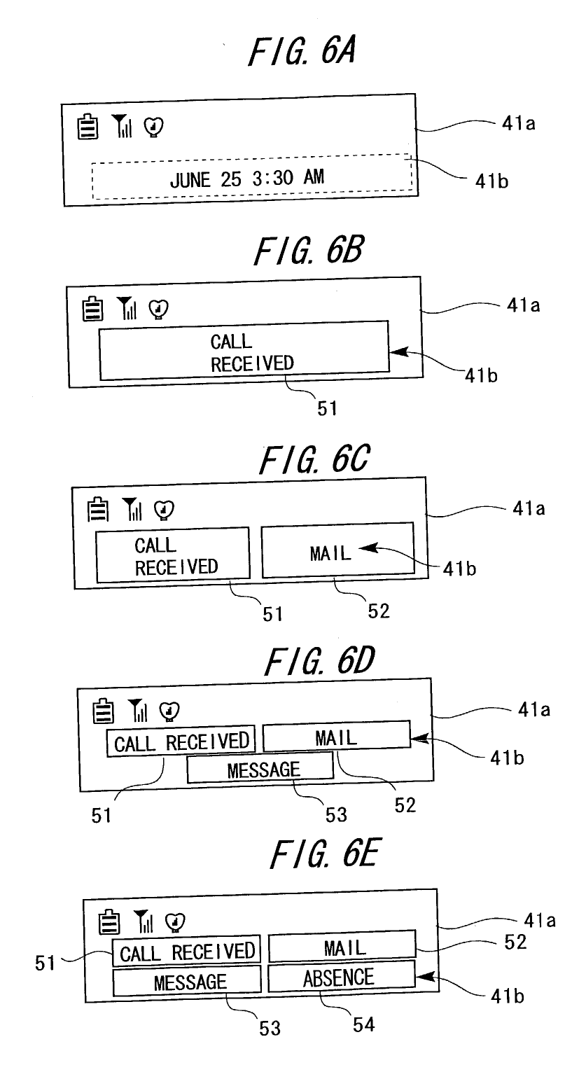

FIG. 6(a) illustrates the sub-display in the standby status, and the character display area 41b on this sub-display is defined by a dotted line.

Then, FIG. 6 (b) shows an example of displaying one category of characters. FIG. 6(c) shows an example of displaying two categories of characters. FIG. 6(d) shows an example of displaying three categories of characters. FIG. 6(e) shows an example of displaying four categories of characters.

Thus, according to the present invention, the same effects as those in the embodiment discussed above can be obtained even by the scheme of displaying the characters in a plurality of rows.

What is claimed is:

1. An information processing terminal comprising:
a character storage unit storing characters corresponding to an event;
an event detection unit detecting an occurrence of the event;
a character count detection unit detecting a character count of characters displayed based on the event detected by said event detection unit;
a size determining unit determining a character display size corresponding to the character count;
a character search unit searching out the characters corresponding to the event detected by said event detection unit from said character storage unit; and
a display control unit having the characters displayed in the display size.

2. An information processing terminal according to claim 1, wherein said display control unit displays, in the case of displaying plural categories of characters, the characters in a predetermined sequence corresponding to these categories.

3. An information processing terminal according to claim 1, wherein said size determining unit determines the display size so as to obtain a size into which the display area is equally divided by the character count.

4. An information processing terminal according to claim 1, wherein said display control unit displays the characters in a way that arrays the characters in a plurality of directions.

5. A storage medium readable by a computer, tangible embodying a program of instructions executable by the computer to perform method steps comprising:
detecting an occurrence of an event;
detecting a character count of characters displayed based on the event detected;
determining a character display size corresponding to the character count;
searching out the characters corresponding to the detected event from a character storage unit; and
having the characters displayed in the display size.

6. A storage medium readable by a computer tangible embodying a program according to claim 5, wherein the display of the characters involves displaying the characters in a predetermined sequence corresponding to categories of the characters.

7. A storage medium readable by a computer tangible embodying a program according to claim 5, wherein the determination of the size involves determining the display size so as to obtain a size into which the display area is equally divided by the character count.

8. A storage medium readable by a computer tangible embodying a program according to claim 5, wherein the display of the characters involves displaying the characters in a way that arrays the characters in a plurality of directions.

9. An event display method executed by an information processing terminal, comprising:
detecting an occurrence of an event;
detecting a character count of characters displayed based on the event detected;
determining a character display size corresponding to the character count;
searching out the characters corresponding to the detected event from a character storage unit; and
having the characters displayed in the display size.

10. An event display method executed by an information processing terminal according to claim 9, wherein the display of the characters involves displaying the characters in a predetermined sequence corresponding to categories of the characters.

11. An event display method executed by an information processing terminal according to claim 9, wherein the determination of the size involves determining the display size so as to obtain a size into which the display area is equally divided by the character count.

12. An event display method executed by an information processing terminal according to claim 9, wherein the display of the characters involves displaying the characters in a way that arrays the characters in a plurality of directions.
